(19) United States
(12) Patent Application Publication
(10) Pub. No.: US 2026/0126212 A1
(43) Pub. Date: May 7, 2026

(54) Water Heater Gas Valve Shank Assembly And Method Of Manufacture

(71) Applicants: Joseph John Ledvora, Itasca, IL (US); James E. Pearson, Itasca, IL (US)

(72) Inventors: Joseph John Ledvora, Itasca, IL (US); James E. Pearson, Itasca, IL (US)

(21) Appl. No.: 19/311,064

(22) Filed: Aug. 27, 2025

Related U.S. Application Data
(60) Provisional application No. 63/714,905, filed on Nov. 1, 2024.

(51) Int. Cl. F24H 15/36; G01K 1/14

(52) U.S. Cl. CPC F24H 15/36; G01K 1/14

(57) ABSTRACT

A water heater gas valve shank assembly has a temperature sensor mechanically retained in a body connected to a water heater. The temperature sensor has a support which receives at least one thermistor at a first end. The support spaces the at least one thermistor from interior surfaces of a tube portion of the temperature sensor with the temperature sensor and body forming a watertight seal. The temperature sensor provides temperature indication to a thermostat to assist in controlling operation of a gas valve providing gas to a burner in the water heater.

### CLAIM OF PRIORITY

This application claims the benefit of US Provisional Application No. 63/714,905 filed Nov. 1, 2024, which is incorporated by reference in its entirety herein.

### FIELD OF THE INVENTION

The present invention relates to water heaters, and more particularly, to a water heater gas valve shank assembly that mounts to a water heater and preferably locates a temperature sensor within the water heater.

### BACKGROUND OF THE INVENTION

Water heaters are utilized to provide hot water within buildings such as homes, business settings, and other locations where the temperature of water is desired to be elevated relative to water provided from a water utility company or a well. Most water heaters have at least one heating element whether it be gas or electrical in nature. A thermostat is usually used to direct a specific outlet water temperature of the water heater. The thermostat receives signals from a temperature sensor in a tank of the water heater.

If a temperature drops below a predetermined setting, the thermostat directs the increase of heating of (or turns on) the gas burner to increase temperature of water in the water tank. When temperature exceeds a second setting, the thermostat directs the decrease of heating from the gas burner (or turns it off).

A number of companies provide gas valves for water heaters and related components. Modern gas water heaters often have a temperature sensor connected physically by a drywell to a gas valve and a thermostat outside of the water tank while the temperature sensor extends into the tank of the water tank.

While drywells with sensors exist in the marketplace, improvements to this structure are believed to be desirable.

### SUMMARY OF THE INVENTION

It is another object of many embodiments of the present invention to provide an improved assembly for directing a temperature sensor into a tank of water heater.

It is another object of many embodiments of the present invention to provide an improved method and apparatus for inserting a temperatures sensor in a water heater.

It is another object of many embodiments of the present invention to provide an improved water heater.

It is another object of many embodiments of the present invention to provide an improved water heater valve system.

Accordingly, a water heater has a drywell for use with a water heater temperature sensor directs output of a temperatures sensor to a thermostat which controls a gas valve. A temperature sensor portion receives at least a portion of a temperature sensor therein. For at least some embodiments, the temperature sensor is at least one thermistor which connects to a support. The support may have slots which respectively receive thermistors. The temperatures sensor portion has a tube with opposing internal grooves which receive the support therebetween. The support may have a width slightly larger than the inner diameter of the grooves. The support may be used to hold a cap end on the temperature sensor portion while connecting the cup to the tube.

The sensor body portion may be rolled to provide grooves to provide locations to receive O-rings to cooperate with sealing/connecting the temperature sensor portion to a body.

The body or the sensor body portion has a stop tab which limits insertion of the sensor body portion relative to the body. The temperature sensor portion is preferably press fit into the body until the stop tab stops further insertion. A barb tab, either on the sensor body portion or the body, may contact an edge of a groove or other location, to assist in prevent the temperature sensor body from pulling out of the body. An interference fit between the exterior of the temperature sensor portion and the body may assist in preventing rotation of the temperature sensor portion relative to the body when installed.

Wires extend through a rear of the temperature sensor portion through a bore of the body to connect with a thermostat which directs the operation of a gas valve external to the water tank of the water heater.

### BRIEF DESCRIPTION OF THE DRAWINGS

The particular features and advantages of the invention as well as other objects will become apparent from the following description taken in connection with the accompanying drawings in which:

FIG. 1 is a cross-sectional view of a water heater gas valve assembly of a presently preferred embodiment of the present invention connected to a water heater;

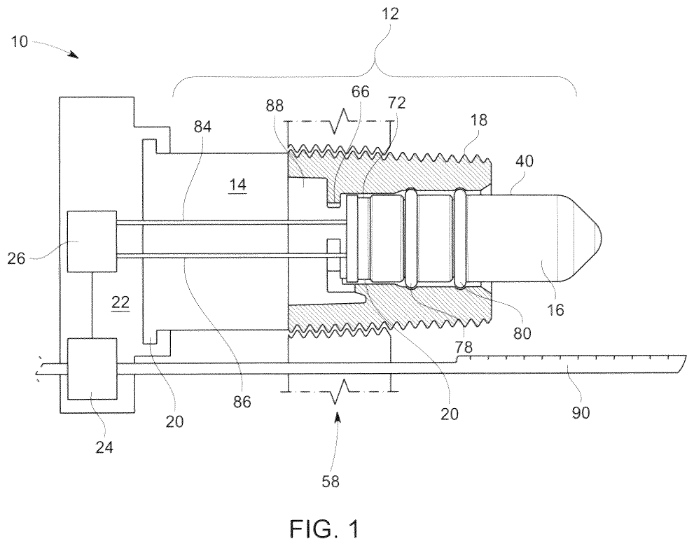

FIG. 2 is a cross-sectional view of the shaft assembly of the water heater gas valve assembly of FIG. 1 with the temperature sensor portion slightly oversized showing installation of the temperature sensor portion relative to the body and internal portions of the temperature sensor portion.

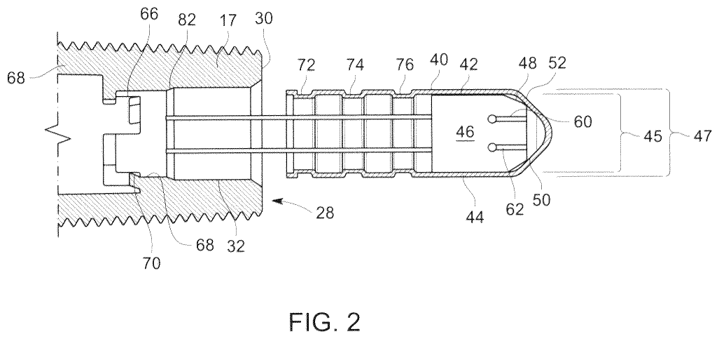

### DETAILED DESCRIPTION OF THE PREFERRED EMBODIMENTS

A water heater gas valve 10 has a shank assembly 12 having a body 14 and a temperature sensor portion 16. The body 14 may be cast, machined or otherwise formed and preferably has externally directed threads 18. Body 14 may have a base 20 received in a tray 22 which preferably houses gas valve 24 and thermostat 26, if not other components as well. Body 14 and temperature sensor portion 16 may be brass or other appropriate material(s).

Temperature sensor portion 16 preferably begins as a tube 40. Opposing grooves 42,44 may be provided such as by machining on interior surface of tube 40. A support 46, which could be plastic, paper or other material, may have a width 47 possibly slightly greater than a diameter 45 between the grooves 42,44 so that when the support 46 is installed, it is held at a desired position in the grooves 42,44.

The support 46 may have front angled surfaces 48,50 which may contact a cap or potting assembly 52 in an effort to locate thermistor(s) 54,56 at a desired location relative to the potting assembly 52 to potentially optimize thermal transfer for at least relatively accurately sense temperature in a water heater 58. Support 46 may have slot(s) 60,62 which receive thermistor(s) 54,56, etc., respectively.

The temperature sensor portion 16 is preferably press fit into a front 28 of body 14. Well 30 may have a larger diameter than first bore portion 32 to assist in positioning temperature sensor portion 16 relative to the body 14. A second bore portion 64 may be slightly smaller than a width of the tube 40 to provide an interference fit with a portion of the temperature sensor portion 16 thereby preventing rotation when the temperature sensor portion 16 is press fit into the body 14 when utilized. A tab stop 66 may limit the amount the temperature sensor portion 16 can be press fit into the body 14. The tab stop 66 may be a portion of the body 14, such as at an end 68 of the second bore portion 64. Other stops could be provided with other embodiments such as a stop extending from an exterior portion of the tube 40 could contact the front 28 of the body 14 at full insertion of the temperature sensor portion 16 relative to the body 14.

Barb stop 70 may be connected to tube 40 or body 14 to assist in preventing tube 40 from pulling out of body 14 once inserted. As illustrated, barb stop 70 extends into a first exterior groove 72 which could be rolled into exterior of tube 40. The barb stop 70 contacts an edge of first exterior groove 72 when attempting to pull the temperature sensor portion 16 out of the body 14.

Second and/or third exterior grooves 74,76, preferably receive O-rings 78,80 which may contact first bore portion 32 or other portion of body 14 to assist in providing a waterproof seal between temperature sensor portion 16 and body 14. Transition 82 may provide a slope or curve between first and second bore portions 32,64. Of course transition 82 could be an instantaneous change (right angle to both) as well.

Body 14 may be brass or other material. Temperature sensor portion 16 may be brass or other material as well. With the thermistor(s) 54,56 installed, wires 84,86 preferably extend from the rear 88 of the temperature sensor portion 16 through a bore 88 of the body 14 or otherwise to then connect to a thermostat 26 in the tray 22. The thermostat 26 connects to a gas valve 24. When temperature sensed by the thermistor(s) 54,56 drops below a first predetermined temperature, thermostat 26 directs the gas valve 24 to open, or open more, to provide more gas to a gas burner 90 in the water heater 58. When temperature sensed by the thermistor(s) 54,56 exceeds a second predetermined temperature, thermostat directs the gas valve 24 to close, or at least partially close to provide less, or no gas to the gas burner 90 in the water heater 58.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A water heater gas valve shank assembly comprising:
a body
a temperature sensor portion having a tube portion mechanically retained within the body;
said temperature sensor having at least one thermistor retained by a support within the temperature sensor with the at least one thermistor spaced apart from an interior surface of the temperature support at a sealed first end of the temperature sensor; and
a watertight seal sealing an external portion of the temperature sensor to an interior portion of the body assisting in preventing water from entering the temperature sensor.

2. The water heater gas valve shank assembly of claim 1 wherein the body has externally directed threads on the body.

3. The water heater gas valve shank assembly of claim 2 in combination with a water heater having internally directed threads connected to the externally directed threads on the body.

4. The water heater gas valve shank assembly of claim 3 wherein the body has a base received in a tray extending oppositely from the body relative to the temperature sensor.

5. The water heater gas valve shank assembly of claim 2 wherein the tray houses at least one of gas valve and thermostat.

6. The water heater gas valve shank assembly of claim 2 wherein the tray houses both the gas valve and the thermostat.

7. The water heater gas valve shank assembly of claim 1 wherein the temperatures sensor has opposing grooves on the interior surface and the support contacts the opposing grooves.

8. The water heater gas valve shank assembly of claim 7 wherein the support is mechanically fit within the opposing grooves.

9. The water heater gas valve shank assembly of claim 1 where a second end of the temperature sensor opposite the first end has an opening and at least one wire extends through the opening to the at least one thermistor.

10. The water heater gas valve shank assembly of claim 9 wherein the body has a bore through which the at least one wire passes through.

11. The water heater gas valve shank assembly of claim 10 wherein the at least one wire connects to a thermostat.

12. The water heater gas valve shank assembly of claim 11 wherein the thermostat is connected to a gas valve controlling gas flow to a burner in a water heater.

13. The water heater gas valve shank assembly of claim 12 wherein the thermostat and gas valve are located in a tray connected to the body.

14. The water heater gas valve shank assembly of claim 12 wherein when the thermostat receives indication that a temperature at the temperature sensor drops below a first predetermined amount, the thermostat directs the gas valve to open more.

15. The water heater gas valve shank assembly of claim 14 wherein when the thermostat receives indication that a temperature at the temperature sensor rises above a second predetermined amount, the thermostat directs the gas valve to provide less gas flow.

16. The water heater gas valve shank assembly of claim 1 further comprising a tab stop preventing insertion of a second end of the temperature sensor into the body past a predetermined position.

17. The water heater gas valve shank assembly of claim 16 further comprising a barb stop contacting an exterior surface of the temperature sensor, said barb stop assisting in preventing temperature sensor from pulling out of the body.

18. The water heater gas valve shank assembly of claim 17 further comprising at least one groove in an exterior surface of the temperature sensor and the barb stop engaging one of the at least one groove.

19. The water heater gas valve shank assembly of claim 18 wherein the at least one groove further comprising at least two grooves, a first groove engaging the barb stop and a second groove having an O-ring thereabout.
